(19) United States
(12) Patent Application Publication
(10) Pub. No.: US 2024/0133701 A1
(43) Pub. Date: Apr. 25, 2024

(54) TRAVEL PLAN FORMULATION APPARATUS

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Ibuki SHIMADA, Miyoshi-shi Aichi-ken (JP)

(73) Assignee: TOYOTA JIDOSHA KABUSHIKI KAISHA, Toyota-shi Aichi-ken (JP)

(21) Appl. No.: 18/381,707

(22) Filed: Oct. 18, 2023

(30) Foreign Application Priority Data
Oct. 20, 2022 (JP) 2022-169486

(51) Int. Cl. G01C 21/34

(52) U.S. Cl. CPC G01C 21/3461; G01C 21/3492

(57) ABSTRACT

A travel plan formulation apparatus according to the present disclosure is a travel plan formulation apparatus including a controller configured to acquire a travel plan for a vehicle and road information regarding an intrusion restricted road on which the intrusion of people into a roadway is restricted, determine, based on the road information, whether a travel route included in the travel plan includes a road other than the intrusion restricted road, and upon detecting that the travel route includes the road other than the intrusion restricted road, modify the travel route so as to avoid the road other than the intrusion restricted road.

### CROSS-REFERENCE TO RELATED APPLICATION

This application claims priority to Japanese Patent Application No. 2022-169486, filed on Oct. 21, 2022, the entire contents of which are incorporated herein by reference.

### TECHNICAL FIELD

The present disclosure relates to a travel plan formulation apparatus.

### BACKGROUND

Technology for formulating travel plans for vehicles in consideration of safety is known. For example, Patent Literature (PTL) 1 discloses setting a travel route for an automated driving vehicle to a destination, in consideration of the level of danger on the travel route.

### CITATION LIST

### Patent Literature

PTL 1: JP 2021-025931 A

### SUMMARY

Technology for formulating travel plans for vehicles in consideration of safety is in need of further improvement in usefulness. For example, in formulating travel plans, the probability of occurrence of traffic accidents resulting in injury or death is required to be reduced.

It would be helpful to improve the usefulness of technology for formulating travel plans for vehicles in consideration of safety.

A travel plan formulation apparatus according to an embodiment of the present disclosure is a travel plan formulation apparatus including a controller configured to:
acquire a travel plan for a vehicle and road information regarding an intrusion restricted road on which intrusion of people into a roadway is restricted;
determine, based on the road information, whether a travel route included in the travel plan includes a road other than the intrusion restricted road; and
upon detecting that the travel route includes the road other than the intrusion restricted road, modify the travel route so as to avoid the road other than the intrusion restricted road.

According to an embodiment of the present disclosure, the usefulness of technology for formulating travel plans for vehicles in consideration of safety is improved.

### BRIEF DESCRIPTION OF THE DRAWINGS

In the accompanying drawings:

FIG. 1 is a block diagram illustrating a schematic configuration of a travel plan formulation system according to an embodiment of the present disclosure;

FIG. 2 is a block diagram illustrating a schematic configuration of a vehicle;

FIG. 3 is a block diagram illustrating a schematic configuration of a server; and

FIG. 4 is a flowchart illustrating operations of the travel plan formulation system.

### DETAILED DESCRIPTION

Hereinafter, an embodiment of the present disclosure will be described.

### Outline of Embodiment

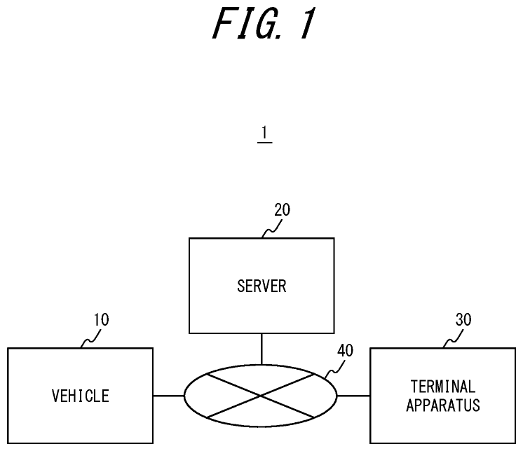

With reference to FIG. 1, an outline of a travel plan formulation system 1 according to an embodiment of the present disclosure will be described. FIG. 1 is a block diagram illustrating a schematic configuration of the travel plan formulation system 1. The travel plan formulation system 1 includes a vehicle 10, a server 20, and a terminal apparatus 30.

The vehicle 10 is any vehicle, such as a bus, a passenger car, or a motorcycle. In the present embodiment, the vehicle 10 shall be an automated driving vehicle that can travel at least partially by automated driving. The automated driving level is, for example, any one of Level 1 to Level 5 according to the level classification defined by the Society of Automotive Engineers (SAE). The vehicle 10 may be driven by a driver or by remote control.

The server 20 is configured by one or more computers. In the present embodiment, the server 20 will be described as being configured by a single computer. However, the server 20 may be configured by multiple computers that can communicate with each other, such as a cloud computing system.

The terminal apparatus 30 is a smartphone, for example, but not limited to this and may be any computer such as a personal computer or a tablet terminal.

For the sake of simplicity, FIG. 1 illustrates one each of the vehicle 10, the server 20, and the terminal apparatus 30. However, the travel plan formulation system 1 may include any number of vehicles 10, servers 20, and terminal apparatuses 30. The vehicle 10, the server 20, and the terminal apparatus 30 are communicably connected to a network 40 including, for example, the Internet, a mobile communication network, or the like.

First, an outline of the present embodiment will be described, and details thereof will be described later. The travel plan formulation system 1 is used, for example, to formulate a travel plan for the vehicle 10. The server 20, which serves as a travel plan formulation apparatus, acquires a travel plan for the vehicle 10 and road information regarding intrusion restricted roads on which the intrusion of people into the roadways is restricted. The server 20 determines, based on the road information, whether a travel route included in the travel plan includes a road other than the intrusion restricted roads. Upon detecting that the travel route includes the road other than the intrusion restricted roads, the server 20 modifies the travel route so as to avoid the road other than the intrusion restricted roads.

Thus, according to the present embodiment, the probability of occurrence of a traffic accident resulting in injury or death during the travel of the vehicle 10 can be reduced by prioritizing roads on which pedestrians and other people are less likely to intrude into the roadways in selection of the travel route. Therefore, according to the present embodiment, the usefulness of technology for formulating travel plans for vehicles in consideration of safety is improved.

In the present embodiment, the “travel plan” for the vehicle 10 is a travel schedule for the vehicle 10. The travel plan for the vehicle 10 includes, for example, information on a departure point, a transit point, a destination point, a travel route along which the vehicle 10 travels, a travel time period, a scheduled departure time from the departure point, a scheduled arrival time at the transit point, a scheduled arrival time at the destination point, a total travel time, a total travel distance, a fuel consumption for the travel, weather along the travel route during the travel time period, and the like. However, the travel plan for the vehicle 10 may include information other than the information described above.

In the present embodiment, the “intrusion restricted roads” are roads on which the intrusion of people into the roadways is restricted. The intrusion restricted roads include, for example, pedestrian-vehicle separated roads in which pedestrian paths are separated from the roadways by a physical structure such as guardrails, curbs, or steps. The intrusion restricted roads include roads in which bike lanes are provided and bike paths are separated from the roadways by a physical structure. Furthermore, the intrusion restricted roads include automobile roads such as highways. However, the intrusion restricted roads are not limited to those mentioned above. In a case in which a single road includes multiple roadways, whether the road is an intrusion restricted road may be determined on a lane-by-lane basis and on a direction-of-travel basis. For example, in the case of a road including two roadways in different directions, when only one of the two roadways has guardrails or the like installed to restrict the intrusion of people, this road can be determined to be an intrusion restricted road only when a vehicle travels on that one roadway.

In the present embodiment, the “road information regarding intrusion restricted roads” includes information capable of identifying the intrusion restricted roads. For example, the road information regarding intrusion restricted roads is a map on which information on the intrusion restricted roads is mapped, but is not limited to this. The road information regarding intrusion restricted roads may include information capable of identifying roads other than the intrusion restricted roads. The “roads other than the intrusion restricted roads” include, for example, roads in which pedestrian or bicycle paths are not separated from the roadways by a physical structure, such as roads in which the roadways are marked by demarcation lines (white lines) or roads in which there are no demarcation lines, but are not limited to these.

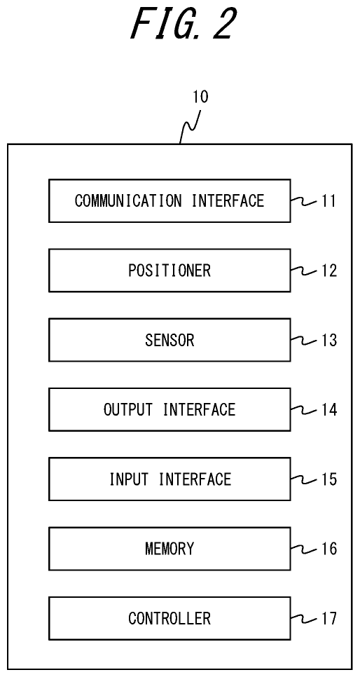

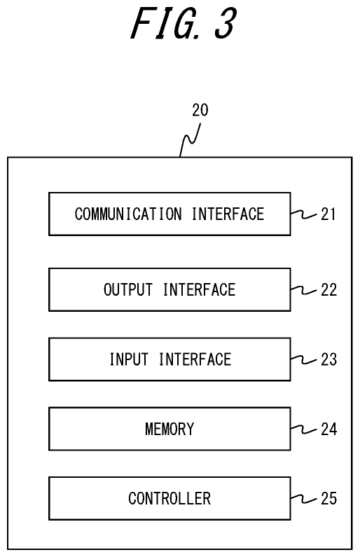

Next, with reference to FIGS. 2 and 3, configurations of the travel plan formulation system 1 will be described in detail. FIG. 2 is a block diagram illustrating a schematic configuration of the vehicle 10. FIG. 3 is a block diagram illustrating a schematic configuration of the server 20.

(Configuration of Vehicle)

As illustrated in FIG. 2, the vehicle 10 includes a communication interface 11, a positioner 12, a sensor 13, an output interface 14, an input interface 15, a memory 16, and a controller 17. The communication interface 11, the positioner 12, the sensor 13, the output interface 14, the input interface 15, the memory 16, and the controller 17 are communicably connected to each other via an in-vehicle network, such as a Controller Area Network (CAN), or dedicated lines, for example.

The communication interface 11 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi® (Wi-Fi is a registered trademark in Japan, other countries, or both), Bluetooth® (Bluetooth is a registered trademark in Japan, other countries, or both), or an infrared communication standard. In the present embodiment, the vehicle 10 is connected to the network 40 via the communication interface 11. This enables the vehicle 10 to communicate with the server 20 or the like.

The positioner 12 includes one or more positioning apparatuses capable of generating positional information on the vehicle 10. The positional information on the vehicle 10 is, for example, coordinates such as the two-dimensional coordinates or three-dimensional coordinates of a location at which the vehicle 10 is present.

The positioner 12 generates the positional information on the vehicle 10 by navigation using a satellite positioning system, autonomous navigation, or a combination of these. The positioner 12 may include a receiver compatible with a satellite positioning system such as the Global Positioning System (GPS) to generate the positional information on the vehicle 10 by navigation using the satellite positioning system. The positioner 12 may include a sensor such as an acceleration sensor or a gyro sensor, to generate the positional information on the vehicle 10 by autonomous navigation.

The sensor 13 includes one or more sensors capable of sensing a person who is present around the vehicle 10. For example, the sensor is Light Detection and Ranging or Laser Imaging Detection and Ranging (LIDAR), Radio Detecting and Ranging (RADAR), or the like, but is not limited to these.

The output interface 14 includes at least one output apparatus. The output apparatus included in the output interface 14 is, for example, a display, a speaker, a lamp, or the like. The output interface 14 outputs images, sound, light, or the like.

The input interface 15 includes at least one input apparatus. The input apparatus included in the input interface 15 may be, for example, a touch panel, a camera, a microphone, or the like. The input interface 15 accepts input operations by a user.

The memory 16 is, for example, a semiconductor memory, a magnetic memory, an optical memory, or the like. The memory 16 may function as, for example, a main memory, an auxiliary memory, or a cache memory. The memory 16 stores any information to be used for operations of the vehicle 10. For example, the memory 16 stores a system program, an application program, embedded software, or the like. The information stored in the memory 16 may be updated with, for example, information acquired from the network 40 via the communication interface 11.

The controller 17 includes at least one processor. The processor may be, for example, a general purpose processor such as a Central Processing Unit (CPU), a dedicated processor that is dedicated to specific processing, or the like. The controller 17 is not limited to a processor and may include at least one dedicated circuit. Examples of dedicated circuits may include a Field-Programmable Gate Array (FPGA) and an Application Specific Integrated Circuit (ASIC). The controller 17 controls the components, such as the communication interface 11, the positioner 12, the sensor 13, the output interface 14, the input interface 15, and the memory 16 that are described above, in order to realize the functions of the vehicle 10, including the functions of the components. The controller 17 may be, for example, an Autonomous Driving System (ADS), Advanced Driver Assistance Systems (ADAS), an Electronic Control Unit (ECU), or a car navigation system for the vehicle 10.

(Configuration of Server)

As illustrated in FIG. 3, the server 20 includes a communication interface 21, an output interface 22, an input interface 23, a memory 24, and a controller 25. The communication interface 21, the output interface 22, the input interface 23, the memory 24, and the controller 25 are communicably connected to one another by wire or wirelessly.

The communication interface 21 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with a short-range wireless communication standard such as Wi-Fi®, Bluetooth®, or an infrared communication standard. In the present embodiment, the server 20 is connected to the network 40 via the communication interface 21. This enables the server 20 to communicate with the vehicle 10, the terminal apparatus 30, and the like.

The output interface 22 includes at least one output apparatus. The output apparatus included in the output interface 22 is, for example, a display, a speaker, a lamp, or the like. The output interface 22 outputs images, sound, light, or the like.

The input interface 23 includes at least one input apparatus. The input apparatus included in the input interface 23 may be, for example, a touch panel, a camera, a microphone, or the like. The input interface 23 accepts input operations by a user.

The memory 24 is, for example, a semiconductor memory, a magnetic memory, an optical memory, or the like. The memory 24 may function as, for example, a main memory, an auxiliary memory, or a cache memory. The memory 24 stores any information to be used for operations of the server 20. For example, the memory 24 stores a system program, an application program, embedded software, or the like. The information stored in the memory 24 may be updated with, for example, information acquired from the network 40 via the communication interface 21.

The controller 25 includes at least one processor. The processor may be, for example, a general purpose processor such as a CPU, a dedicated processor that is dedicated to specific processing, or the like. The controller 25 is not limited to a processor and may include at least one dedicated circuit. Examples of the dedicated circuit may include an FPGA and an ASIC. The controller 25 controls the components, such as the communication interface 21, the output interface 22, the input interface 23, and the memory 24 that are described above, in order to realize the functions of the server 20, including the functions of the components.

(Operations of Travel Plan Formulation System)

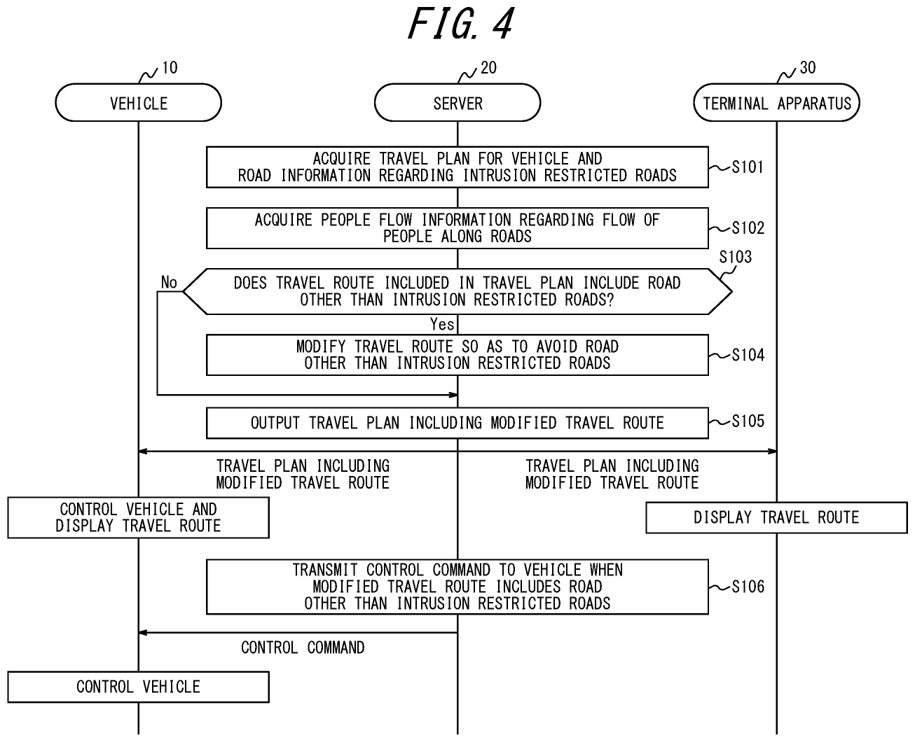

Operations of the travel plan formulation system 1 will be described with reference to FIG. 4. FIG. 4 is a flowchart illustrating the operations of the travel plan formulation system 1. The flowchart illustrated in FIG. 4 indicates operations of the vehicle 10, the server 20, and the terminal apparatus 30 included in the travel plan formulation system 1. Description of these operations corresponds to a control method for the travel plan formulation system 1, and also corresponds to a control method for each of the vehicle 10, the server 20, and the terminal apparatus 30 included in the travel plan formulation system 1.

In step S101, the controller 25 of the server 20 acquires a travel plan for the vehicle 10 and road information regarding intrusion restricted roads on which the intrusion of people into the roadways is restricted.

Any method can be employed to acquire the travel plan for the vehicle 10 and the road information regarding the intrusion restricted roads. For example, the controller 25 of the server 20 may receive the travel plan for the vehicle 10 and the road information regarding the intrusion restricted roads via the communication interface 21 from other systems. Alternatively, the controller 25 of the server 20 may generate the travel plan for the vehicle 10 based on information received from the vehicle 10, the terminal apparatus 30, or other computers via the communication interface 21. The travel plan may be, for example, a time priority plan that minimizes a travel time from a departure point to a destination point, a distance priority plan that minimizes a travel distance from the departure point to the destination point, or the like, but is not limited to these. The controller 25 may store, in the memory 24, the received travel plan for the vehicle 10 and the received road information regarding the intrusion restricted roads.

In step S102, the controller 25 of the server 20 acquires people flow information regarding flows of people along roads.

The “people flow information” is information regarding flows of people along roads. For example, the people flow information can be expressed as the number of people present per a certain distance (pedestrian density) on the roads, but is not limited to this. The people flow information may be generated based on GPS data from smartphones or other devices carried by pedestrians walking on the roads. For example, the people flow information may be statistical data (results of a survey on the number of people walking) provided by a local government or the like. Alternatively, the people flow information may be generated based on the number of pedestrians in images captured by driving recorders traveling on the roads. The people flow information may be, for example, information acquired in real time, past statistical data, predicted values based on the past statistical data, or a combination thereof.

Any method can be employed to acquire the people flow information. For example, the controller 25 of the server 20 can receive the people flow information from the vehicle 10, the terminal apparatus 30, or other systems via the communication interface 21. The controller 25 may store the received people flow information in the memory 24.

In step S103, the controller 25 of the server 20 determines, based on the road information regarding the intrusion restricted roads, whether a travel route included in the travel plan includes a road other than the intrusion restricted roads.

For example, the controller 25 on the server 20 may map the road information regarding the intrusion restricted roads on the travel route included in the travel plan, to determine whether there is a road other than the intrusion restricted roads in the travel route. Upon determining that there is a road other than the intrusion restricted roads in the travel route, the controller 25 may store, in the memory 24, the road other than the intrusion restricted roads included in the travel route for the vehicle 10.

In a case in which it is determined in step S103 that there are no roads other than the intrusion restricted roads in the travel route (No in step S103), the controller 25 of the server 20 performs processes in step S105 and thereafter, without performing a process in step S104. At this time, the controller 25 may regard the current travel route included in the travel plan for the vehicle 10 as a modified travel route due to the process in step S104 and store the current travel route in the memory 24.

On the other hand, it is determined in step S103 that the travel route includes a road other than the intrusion restricted roads (Yes in step S103), the controller 25 of the server 20 proceeds to step S104 and modifies the travel route so as to avoid the road other than the intrusion restricted roads.

Any method can be employed to modify the travel route so as to avoid the road other than the intrusion restricted roads. For example, the controller 25 of the server 20 may regenerate a travel route based on the travel plan for the vehicle 10, excluding the road other than the intrusion restricted roads generated in step S103. As described above, the travel plan for the vehicle 10 includes, for example, information on a departure point, a transit point, a destination point, a travel route, a travel time period, a scheduled departure time from the departure point, a scheduled arrival time at the transit point, a scheduled arrival time at the destination point, a total travel time, a total travel distance, a fuel consumption for the travel, weather along the travel route during the travel time period, and the like. When the vehicle 10 is already traveling on a travel route, the controller 25 may acquire positional information on the vehicle 10 from the vehicle 10 via the communication interface 21. In such a case, the controller 25 may use the positional information on the vehicle 10, instead of the departure point in the travel plan, when modifying the travel plan. Thus, by modifying the travel route so as to avoid the road other than the intrusion restricted roads, the probability of occurrence of a traffic accident resulting in injury or death during the travel of the vehicle 10 can be reduced. The controller 25 may update the travel plan for the vehicle 10 stored in the memory 24 so that the travel plan includes the modified travel route.

In step S104, the controller 25 of the server 20 may further determine whether the road other than the intrusion restricted roads is expected to have a flow of people greater than or equal to a threshold value.

Specifically, the controller 25 of the server 20 may modify the travel route so as to avoid the road other than the intrusion restricted roads, in a case in which the travel route includes the road and in a case in which the road is expected to have a flow of people greater than or equal to a threshold value. On the other hand, even in a case in which the travel route includes the road other than the intrusion restricted roads, the controller 25 may not modify the travel route so as to avoid the road when the road is not expected to have a flow of people greater than or equal to the threshold value. This can prevent an impact on the travel plan by not avoiding roads with low flows of people and with low risks of occurrence of traffic accidents resulting in injury or death, even though the roads are not the intrusion restricted roads on which the intrusion of people into the roadways is restricted.

The threshold value used to determine the flow of people may be determined for each road, for example, according to the size of the road, visibility, past history of traffic accidents resulting in injury or death, and the like. For example, the threshold value may vary depending on a travel time period and/or weather along the travel route during the travel time period. The travel time period may include, for example, morning, daytime, evening, nighttime, and the like, but not limited to these and may include any time of day. For example, even on the same road, the threshold value may be set lower in the nighttime because visibility is lower and traffic accidents resulting in injury or death are more likely to occur in the nighttime than in the daytime. For example, even on the same road, the threshold value may be set lower in rainy weather because visibility is less than in sunny weather and traffic accidents resulting in injury or death are more likely to occur. This improves accuracy in determining roads with high probability of occurrence of traffic accidents resulting in injury or death on the travel route.

In step S104, the controller 25 of the server 20 may further determine whether conditions specified in the travel plan are satisfied in a case in which the travel route is modified.

Specifically, even in a case in which the travel route for the vehicle 10 includes the road other than the intrusion restricted roads, the controller 25 of the server 20 may allow a modified travel route to include the road other than the intrusion restricted roads when by avoiding the road, the conditions specified in the travel plan are not satisfied. The conditions specified in the travel plan are, for example, the conditions of the scheduled arrival time at the transit point, the scheduled arrival time at the destination point, the total travel time, the total travel distance, the fuel consumption for the travel, and the like, but are not limited to these. This reduces the risk of not being able to achieve the conditions specified in the travel plan, such as not being able to reach the destination point by the scheduled arrival time or not being able to reach the destination point due to lack of fuel, by modifying the travel route for the vehicle 10.

In step S105, the controller 25 of the server 20 outputs a travel plan including a modified travel route.

Any method can be employed to output the travel plan including the modified travel route. For example, the controller 25 of the server 20 may output the travel plan itself via the output interface 22, such as a display, or may transmit the travel plan to the vehicle 10, the terminal apparatus 30, or the like via the communication interface 21. The travel plan including the modified travel route can then be used in the vehicle 10 or the terminal apparatus 30 to control the vehicle in automated driving or the like, to display the travel route in a navigation system, or the like. This allows the vehicle 10 to preferentially travel on roads on which pedestrians and other people are less likely to intrude into the roadways, thereby reducing the probability of occurrence of a traffic accident resulting in injury or death during the travel of the vehicle 10.

In step S106, in a case in which the modified travel route includes the road other than the intrusion restricted roads, the controller 25 of the server 20 may be configured to transmit, to the vehicle 10, a control command to improve safety while the vehicle 10 is traveling on the road other than the intrusion restricted roads. For example, the control command may include a control command to increase the sensitivity of the sensor 13 of the vehicle 10 to detect a person while the vehicle 10 is traveling on the road other than the intrusion restricted roads. Alternatively, the control command may include a control command to reduce an upper limit of the travel speed of the vehicle 10 while the vehicle 10 is traveling on the road other than the intrusion restricted roads. Therefore, even in a case in which the road other than the intrusion restricted roads cannot be avoided and is included in the modified travel route, the probability of occurrence of a traffic accident resulting in injury or death during the travel of the vehicle 10 can be reduced.

The control command to improve safety while the vehicle 10 is traveling on the road other than the intrusion restricted roads may further include a control command to increase the upper limit of the travel speed of the vehicle 10 on the intrusion restricted roads. The upper limit of the travel speed of the vehicle 10 may be set for each road within a speed limit set for the road. This prevents a delay in the overall travel plan, even in a case in which time spent for traveling on the road other than the intrusion restricted roads is increased to improve safety.

The operations from step S101 to step S106 described above may be performed before the vehicle 10 travels according to the travel plan, or may be performed while the vehicle 10 is traveling according to the travel plan. The operations described above may be repeated before or during the travel of the vehicle 10. This allows the use of the latest people flow information or the like. Therefore, an impact on the travel plan can be reduced, while the probability of occurrence of a traffic accident resulting in injury or death during the travel of the vehicle 10 is reduced.

As described above, the server 20, which serves as a travel plan formulation apparatus according to the present embodiment, acquires a travel plan for the vehicle 10 and road information regarding intrusion restricted roads on which the intrusion of people into the roadways is restricted. The server 20 determines, based on the road information, whether a travel route included in the travel plan includes a road other than the intrusion restricted roads. Upon detecting that the travel route includes the road other than the intrusion restricted roads, the server 20 modifies the travel route so as to avoid the road other than the intrusion restricted roads.

According to such a configuration, the probability of occurrence of a traffic accident resulting in injury or death during the travel of the vehicle 10 can be reduced by prioritizing roads on which pedestrians and other people are less likely to intrude into the roadways in selection of the travel route. Therefore, according to the present embodiment, the usefulness of technology for formulating travel plans for vehicles in consideration of safety is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the aforementioned embodiment, all or some of the functions or processes described as the functions or processes of the server 20 may be realized as the functions or processes of the vehicle 10. Specifically, a program in which processes for realizing all or some of the functions of the server 20 according to the above embodiment are written may be stored in the memory 16 of the vehicle 10, and the program may be read and executed by the controller 17. Similarly, all or some of functions or processes described as the functions or processes of the vehicle 10 may be realized as the functions or processes of the server 20.

For example, an embodiment in which a general purpose computer functions as the controller 17 of the vehicle 10 or the server 20 according to the above embodiment can also be implemented. Specifically, a program in which processes for realizing the functions of the controller 17 of the vehicle 10 or the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program. Examples of the non-transitory computer readable medium include a magnetic storage device, an optical disc, a magneto-optical storage device, and a semiconductor memory.

1. A travel plan formulation apparatus comprising a controller configured to:
acquire a travel plan for a vehicle and road information regarding an intrusion restricted road on which intrusion of people into a roadway is restricted;
determine, based on the road information, whether a travel route included in the travel plan includes a road other than the intrusion restricted road; and
upon detecting that the travel route includes the road other than the intrusion restricted road, modify the travel route so as to avoid the road other than the intrusion restricted road.

2. The travel plan formulation apparatus according to claim 1, wherein the controller is configured to:
further acquire people flow information regarding flows of people along roads; and
modify the travel route so as to avoid the road other than the intrusion restricted road in a case in which the travel route includes the road other than the intrusion restricted road and in a case in which the road other than the intrusion restricted road is expected to have a flow of people greater than or equal to a threshold value.

3. The travel plan formulation apparatus according to claim 2, wherein
the travel plan further includes a travel time period, and
the threshold value varies according to the travel time period and/or weather along the travel route during the travel time period.

4. The travel plan formulation apparatus according to claim 1, wherein even in a case in which the travel route includes the road other than the intrusion restricted road, the controller is configured to allow a modified travel route to include the road other than the intrusion restricted road when by avoiding the road other than the intrusion restricted road, a condition specified in the travel plan is not satisfied.

5. The travel plan formulation apparatus according to claim 4, wherein
the vehicle includes a sensor capable of sensing a person present around the vehicle, and
in a case in which the modified travel route includes the road other than the intrusion restricted road, the controller is configured to transmit, to the vehicle, a control command to increase sensitivity of the sensor to sense a person while the vehicle is traveling on the road other than the intrusion restricted road.
